(19) United States
(12) Patent Application Publication
(10) Pub. No.: US 2009/0022936 A1
(43) Pub. Date: Jan. 22, 2009

(54) Finely Divided Glass Filler For Rubber Latex Adhesive Compositions

(76) Inventor: Shawn David McGill, Dalton, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/235,044

(22) Filed: Sep. 22, 2008

Related U.S. Application Data
(63) Continuation of application No. 11/311,663, filed on Dec. 20, 2005, now abandoned.

(51) Int. Cl. B32B 27/00

(52) U.S. Cl. 428/95

(57) ABSTRACT

Embodiments relate to adhesive compositions for use in carpet backing and other textiles. The adhesive compositions contain a rubber latex formulation including a conjugated diene, finely divided glass particles, and optionally additional fillers. The adhesive compositions provide carpet products having improved lamination strength, and enable higher run speeds, and consequently, increased carpet manufacturing capacity.

### BACKGROUND

1. Field of the Invention

Embodiments relate generally to the use of finely divided glass as a filler for rubber latex materials. The rubber latex materials typically are used as adhesives in the manufacture of a variety of carpet products and other textiles.

2. Description of Related Art

SBR Latex has long been used in the manufacturing of carpets and in other textile manufacturing. In carpet manufacturing, SBR latex has been used to laminate secondary backings to carpet for improved dimensional stability and for ease of installation. SBR latex also penetrates into the fiber bundles on the back of carpet to lock the fiber into the product and eliminate issues of fibers pulling out of the carpet after the carpet is put into use. Fillers typically are incorporated into the SBR latex for a variety of reasons. Calcium carbonate has long been used as a filler for SBR latex used in carpet manufacturing and has been used at various fill rates, depending on the physical properties required of the finished product.

The calcium carbonate filler serves several purposes, not the least of which is to reduce the cost of the SBR latex compound. The filler also imparts flexibility to the finished product for ease of handling and installation. In general, the more filler used, the more flexible the finished product. There is a degradation of some physical properties of the finished product, however, as the filler load increases. The three physical properties that are usually impacted by the amount of filler introduced into the latex are tuft bind strength, lamination strength, and bundle penetration.

Tuft bind strength is the amount of force required to pull a yarn bundle out of the face of the carpet after the SBR latex has been applied to the back of the carpet and cured. Lamination strength is the amount of force required to peel the secondary backing away from the cured SBR latex. Bundle penetration is a visual measurement of how well the latex has penetrated into the individual yarn bundles to lock in the individual fibers of the yarn. The higher the numbers for each of these physical characteristics, the better the carpet should perform over the life of the installed carpet.

Another reason for adding filler to SBR latex is to reduce the curing time required to completely dry the latex compound. In general, the more filler used the shorter the curing time. Shorter curing times result in faster processing speeds, which in turn lower costs and increase production capacity.

Typically, whole carpet comprises nylon, polypropylene or PET pile or tufts, at least one backing formed from one or more polyolefins, such as polypropylene, and an adhesive material of styrene-butadiene rubber (SBR) applied as a latex and filled with an inorganic filler such as calcium carbonate. A typical carpet sample has a pile weight of about 30 oz. per square yard, a backing weight of about 8 oz. per square yard and an adhesive weight (SBR latex and filler) of 32 oz. per square yard. In other words, a nylon (or PET) carpet sample may comprise about 43% nylon (or PET), about 11% polypropylene, and about 46% SBR plus filler.

U.S. Pat. Nos. 4,522,857, 5,540,968, 5,545,276, 5,948,500, and 6,203,881 (all hereby incorporated by reference herein) describe carpet or carpet tiles having cushioned backings. In the tufted carpet, a primary carpet fabric is bonded to an adhesive layer in which is embedded a layer of glass scrim, or fiberglass mat. A foam base composite typically then is adhesively bonded to the adhesive layer. In such tufted carpet construction, the primary carpet fabric includes a loop pile layer tufted through a primary backing such as a non-woven textile by a conventional tufting process and held in place by a pre-coat backing layer of latex or other appropriate adhesive. The foam base composite of the tufted carpet product usually includes an intermediate layer molded to a layer of urethane foam.

The bonded carpet product typically employs the same type of foam base composite adhesively bonded by adhesive laminate layer in which is disposed a layer of glass scrim or fiberglass mat. The primary bonded carpet fabric, however, has somewhat different components from that of the tufted product in that it has cut pile yarns implanted in an adhesive such as PVC, latex, or hot melt adhesive and has a woven or non-woven reinforcement or substrate layer of material such as fiberglass, nylon, polypropylene, or polyester.

U.S. Pat. No. 5,948,500 describes a particularly simple composite structure amenable to continuous, in-line, or in-situ formation of a stable cushion carpet composite. Specifically, a single process is used to bring all the layers of the cushioned carpet composite together by laying a primary carpet fabric or a glass layer, either with or without some degree of preheat, directly into a mechanically frothed polyurethane-forming composition prior to curing the polyurethane and without an intermediate layer of material.

As described in one example of the U.S. Pat. No. 5,948,500, the base of the primary carpet fabric is adhesively bonded to a layer of non-woven glass reinforcement material to form a preliminary composite. Use of glass reinforcement layers together with adhesive layers for carpet backing also is disclosed in, for example, U.S. application publication Nos. 2003/0072911 and 2003/0232171, the disclosures of which are incorporated by reference herein in their entireties.

In most carpet backing applications, SBR latex is used as the adhesive lamination material. The SBR latex material has proven to provide excellent adhesive and other characteristics to the carpet material (either tufted, bonded, cushioned-backed, etc.). Despite the success of SBR latex adhesive materials, the art constantly seeks improvements in terms of lamination strength, processing efficiencies (e.g., curing time, etc.), increased production capacity, and the like.

The description herein of certain advantages and disadvantages of various features, embodiments, methods, and apparatus disclosed in other publications is not intended to limit the scope of the present embodiments. Indeed, the preferred embodiments may include some or all of the features, embodiments, methods, and apparatus described above without suffering from the same disadvantages.

### SUMMARY OF THE INVENTION

There exists a need to provide rubber latex materials having improved lamination strength, and that increase production capacity by reducing processing time. There also exists a need to provide improved rubber latex materials for manufacturing carpets and other textiles. Features of embodiments described herein set out to satisfy these and other needs in the art.

It is a feature of an embodiment to provide unique and improved characteristics of rubber latex by the addition of finely divided glass as an additional filler material. The addition of ground, powdered or crushed glass to rubber latex in addition to, or substituted for some portion of the normal level of calcium carbonate filler results in highly beneficial and significant increases in lamination strength of secondary backings to tufted carpet products.

It is another feature to provide significant reductions in the curing time required for rubber latex by addition of finely divided glass, in addition to, or substituted for, some portion of the normal level of calcium carbonate filler typically employed. This results in reduced processing time and increased production capacity.

In accordance with these features, as well as other features, there is provided an adhesive composition comprising a rubber latex comprised of at least one conjugated diene, finely divided glass particles, and at least one filler. The at least one filler can be calcium carbonate. The composition provides improved processing efficiencies by reducing the curing time and increasing the process speed, and also provides improved lamination strength.

In accordance with an additional feature of an embodiment, there is provided a method of making a carpet that comprises laminating a secondary backing to a primary carpet fabric with an adhesive composition comprising a rubber latex comprised of at least one conjugated diene, finely divided glass particles, and at least one filler.

Another embodiment includes a carpet manufactured in accordance with the above described method, having improved lamination strength, when compared to carpet prepared using an adhesive composition without finely divided glass particles.

### DETAILED DESCRIPTION OF THE PREFERRED EMBODIMENTS

The terminology used herein is for the purpose of describing particular embodiments only, and is not intended to limit the scope of the present invention. As used throughout this disclosure, the singular forms “a,” an, and “the” include plural reference unless the context clearly dictates otherwise. Thus, for example, a reference to “a carpet backing” includes a plurality of such carpet backings, as well as a single carpet backing, and a reference to “an adhesive composition” is a reference to one or more adhesive compositions and equivalents thereof known to those skilled in the art, and so forth.

Unless defined otherwise, all technical and scientific terms used herein have the same meanings as commonly understood by one of ordinary skill in the art to which this invention pertains. Although any methods and materials similar or equivalent to those described herein can be used in the practice or testing of the present invention, the preferred methods, devices, and materials are now described. All publications mentioned herein are cited for the purpose of describing and disclosing the various materials, compositions, and carpet manufacturing methods that are reported in the publications and that might be used in connection with the invention. Nothing herein is to be construed as an admission that the embodiments described herein are not entitled to antedate such disclosures by virtue of prior invention.

An exemplary embodiment includes an adhesive composition that comprises: (a) a rubber latex comprised of at least one conjugated diene; (b) finely divided glass particles; and (c) at least one filler. Another embodiment includes a method of making carpet by laminating a secondary backing to a primary carpet fabric using the adhesive composition. Another exemplary embodiment includes a carpet prepared by the method that has improved lamination strength, when compared to carpet made using an adhesive composition that does not include finely divided glass particles.

As used herein, the expression “finely divided glass particles” denotes crushed, powdered, or ground glass particles. The glass particles can be virgin glass particles, or recycled glass particles. The expression “finely divided glass particles” does not include fiberglass particles, which typically are longer fiber-like glass particles, or glass fabrics. Rather, “finely divided glass particles” denotes glass particles having an average mesh size of from about 40 to about 250 mesh, or more preferably, from about 60 to about 80 mesh. These finely divided glass particles include powdered glass, powdered sand, powdered quartz, powdered silica-containing ceramics, and the like. While preferable, it is not required that the finely divided glass particles have a small weight average particle size, and a narrow size distribution.

The rubber latex can be any suitable conventional rubber latex usually used for application to the back of a carpet, whether a natural rubber latex or a synthetic rubber latex. Synthetic rubber latexes include rubbers derived from conjugated dienes, such as butadiene, isoprene, chloroprene, etc., whether homopolymers of such dienes, or copolymers of such dienes with one or more copolymerizable ethylenically unsaturated monomers such as styrene, alphamethylstyrene, acrylonitrile, methacrylonitrile, acrylic acid, methacrylic acid, itaconic acid, etc. Particularly preferred dienes are the copolymers of butadiene or the like with styrene, modified by including minor amounts of a polar monomer, e.g., an ethylenically unsaturated organic acid such as acrylic acid, itaconic acid (or an ester of such carboxylic acid, such as an alkyl ester), as well as acrylamides, vinyl ethers or alkyl vinyl esters, also amines such as vinyl pyridine and halogen containing monomers such as vinyl chloride or vinylidene chloride. Preferably, the rubber is a styrene-butadiene rubber (SBR) latex, which may or may not be carboxylated.

One class of latex of particular interest is that known as carboxylated latex or acid latex. These include copolymers (in which term we include interpolymers containing two or more monomers) of conjugated dienes with one or more monoethylenically unsaturated copolymerizable monomers, at least one of which has carboxyl functionality, whether a monocarboxylic acid or a polycarboxylic (e.g., dicarboxylic) acid, such as itaconic acid, acrylic acid, methacrylic acid, fumaric acid, citraconic acid, maleic acid, ethyl acid maleate, etc.

The rubber latex typically will include the SBR or carboxylated SBR, water, and an emulsifier. Such latices will normally have a solids content within the range of about 45 percent to about 60 percent. The rubber latex preferably has a solids content within the range of about 48 percent to about 55 percent and most preferably, within the range of about 50 percent to about 52 percent.

The rubber latex can be prepared by free radical emulsion polymerization. The charge compositions used in the preparation of such latices contain the monomers, at least one surfactant, and at least one free radical initiator. The monomer charge composition used in such polymerizations can be comprised of, for example: (a) styrene monomer; (b) 1,3-butadiene monomer; and optionally, (c) an unsaturated carboxylic acid monomer. The charge composition used in the preparation of the latex typically contains a substantial quantity of water. The ratio between the total amount of monomers present in the charge composition and water can range between about 0.2:1 and about 1.2:1.

The charge composition may also contain from about 0.2 phm (parts per hundred parts of monomer) to about 6 phm of at least one emulsifier. It is normally preferred for the emulsifier (surfactant) to be present in the polymerization medium at a level within the range of about 1 phm to about 5 phm. It is generally more preferred for the charge composition to contain from about 2 phm to about 4 phm of the emulsifier.

The emulsifiers used in the polymerization can be charged at the outset of the polymerization or may be added incrementally or by proportioning as the reaction proceeds. Generally, anionic emulsifier systems provide good results; however, any of the general types of anionic, cationic or nonionic emulsifiers may be employed in the polymerization.

Suitable anionic emulsifiers that can be employed in emulsion polymerizations include napthenic acids and their soaps and the like; sulfuric esters and their salts, such as the tallow alcohol sulfates, coconut alcohol sulfates, fatty alcohol sulfates, such as oleyl sulfate, sodium lauryl sulfate and the like; sterol sulfates; sulfates of alkylcyclohexanols, sulfation products of lower polymers of ethylene as C₁₀ to C₂₀ straight chain olefins and other hydrocarbon mixtures, sulfuric esters of aliphatic and aromatic alcohols having intermediate linkages, such as ether, ester or amide groups such as alkylbenzyl (polyethyleneoxy) alcohols, the sodium salt of tridecyl ether sulfate; alkane sulfonates, esters and salts, such as alkylchlorosulfonates with the general formula RSO₂Cl, wherein R is an alkyl group having from 10 to 20 carbon atoms and alkylsulfonates with the general formula RSO₂—OH, wherein R is an alkyl group having from 1 to 20 carbon atoms; sulfonates with intermediate linkages such as ester and ester-linked sulfonates such as those having the formula RCOOC₂ H₄ SO₃ H and ROOC—CH₂—SO₃ H, wherein R is an alkyl group having from 1 to 20 carbon atoms such as dialkyl sulfosuccinates; ester salts; alkaryl sulfonates in which the alkyl groups contain preferably from 10 to 20 carbon atoms, e.g. dodecylbenzenesulfonates, such as sodium dodecylbenzenesulfonates; alkyl phenol sulfonates; sulfonic acids and their salts such as acids with the formula RSO₃ Na, wherein R is an alkyl and the like; sulfonamides; sulfamido methylenesulfonic acids; rosin acids and their soaps; sulfonates derivatives of rosin and rosin oil; and lignin sulfonates and the like.

The polymerization typically is initiated using free radical generators, ultraviolet light or radiation. To ensure a satisfactory polymerization rate, uniformity and a controllable polymerization, free radical initiators are generally used. The free radical generator is normally employed at a concentration within the range of about 0.01 phm to about 1 phm. The free radical initiators that are commonly used include the various peroxygen compounds such as potassium persulfate, ammonium persulfate, benzoyl peroxide, hydrogen peroxide, di-t-butyl peroxide, dicumyl peroxide, 2,4-dichlorobenzoyl peroxide, decanoyl peroxide, lauryl peroxide, cumene hydroperoxide, p-menthane hydroperoxide, t-butyl hydroperoxide, acetyl peroxide, methyl ethyl ketone peroxide, succinic acid peroxide, dicetyl peroxydicarbonate, t-butyl peroxyacetate, t-butyl peroxymaleic acid, t-butyl peroxybenzoate, acetyl cyclohexyl sulfonyl peroxide and the like; the various azo compounds such as 2-t-butylazo-2-cyanopropane, dimethyl azodiisobutyrate, azodiisobutylronitrile, 2-t-butylazo-1-cyanocyclohexane, 1-t-amylazo-1-cyanocyclohexane and the like, the various alkyl perketals, such as 2,2-bis-(t-butyl-peroxy)butane and the like. Water-soluble peroxygen-free radical initiators and redox systems are especially useful in such aqueous polymerizations.

The emulsion polymerization utilized in synthesizing the latices of this invention can be carried out over a broad temperature range from about 0° C. to as high as about 100° C. It is normally preferred for the emulsion polymerization to be carried out at a temperature which is within the range of about 20° C. to about 90° C. It is generally more preferred for the emulsion polymerization to be conducted at a temperature which is within the range of about 35° C. to about 85° C.

After the desired degree of monomer conversion has been attained, a conventional shortstopping agent, such as hydroquinone, can be added to the polymerization medium to end the polymerization. The polymerization will typically be allowed to continue until a high level conversion has been achieved. In most cases, the monomer conversion reached will be at least about 80 percent with monomer conversions of at least about 90 percent being preferred. A suitable rubber latex useful in the embodiments can be prepared in accordance with U.S. Pat. Nos. 5,637,644 and 6,162,848, the disclosure of which is incorporated by reference herein in its entirety.

The adhesive compositions contain, in addition to the rubber latex and finely divided glass particles, optional fillers. Any of the known conventional fillers can be used, and preferably, one filler in addition to the finely divided glass particles is used. Preferably, the additional filler is calcium carbonate, although other fillers such as aluminum hydroxide, magnesium hydroxide, clay, barium sulfate, silicic acid, silicate, titanium oxide, and magnesium carbonate can be used. The amount of filler employed can vary widely depending on the particular application of the adhesive composition, but typically, the filler is utilized in an amount ranging from about 1 part by weight to about 5 parts by weight, per weight of the rubber latex. More preferably, the amount of filler ranges from about 1.5 parts by weight to about 2.5 parts by weight, and most preferably, the amount of filler is about 1.8 to about 2.0 parts by weight filler, per weight of rubber latex.

The adhesive composition contains in addition to the rubber latex and optional filler, finely divided glass particles. These glass particles preferably are in the form of crushed, powdered, or ground glass. The glass particles can be used in an amount of from about 0.1 to about 1.5 parts by weight, based on the weight of the rubber latex, more preferably from about 0.1 to about 0.75 parts by weight, and most preferably from about 0.15 to about 0.50 parts by weight.

The adhesive composition can be employed in manufacturing carpet. This will typically involve coating one side of a carpet backing with the adhesive composition to produce a latex-coated backing. It also is possible to apply the adhesive composition directly to the pile or to apply it to both the backing and the pile. The pile then can be brought into contact with the coated side of the latex-coated backing. Then the adhesive composition is allowed to dry while keeping the pile in contact with the coated side of the latex-coated backing. This is normally done by passing the carpet through a drying oven or a series of drying ovens. During this drying process, the adhesive composition offers improved adhesion characteristics, resulting in improved lamination strength. After substantially all of the water has evaporated from the adhesive composition, the carpet manufacturing process is completed. The finished carpet produced by this technique offers improved tuft-bind and delamination strength, when compared to carpet prepared using adhesive compositions that do not include the finely divided glass particles, but rather employ calcium carbonate as the filler.

The finished carpet produced by this method has a lamination strength that can be anywhere from 10% to 50% greater than the lamination strength achieved using adhesive compositions without the finely divided glass particles. That is, the finished carpet is produced by substituting some of the calcium carbonate filler with finely divided glass particles, and the lamination strength is compared to the lamination strength of an identical carpet product produced using no finely divided glass particles (i.e., no calcium carbonate was substituted with finely divided glass particles). Preferably, the finished carpet has about 12% to about 30% increase in lamination strength, and most preferably about 15% to about 30% increase in lamination strength.

The adhesive compositions of the embodiments also provide for improved curing times, thereby enabling an increase in run speed, or processing time for the finished carpet product. Again, the increase is run speed for the embodiments described herein is compared to the run speed for carpets manufactured using adhesive compositions where none of the calcium carbonate is substituted with finely divided glass particles. The adhesive compositions can provide an increase in run speed ranging from about 10% to about 50%, preferably from about 12% to about 35%, and most preferably from about 15% to about 30%, when compared to carpets prepared with an adhesive composition containing no finely divided glass particles.

The invention now will be described with reference to the following non-limiting examples.

### EXAMPLES

In the following examples, the lamination strength and run speed were measured in accordance with the following testing methodology.

Lamination Strength: The lamination strength was determined using test method ASTM D3936 for determining the number of pounds per inch of force necessary to pull the secondary backing away from the laminating layer. The test results obtained from samples from the trial runs using SBR Latex with added glass filler were compared to previous test results using the same testing protocol from samples of the same products with similar Latex weights coated in the previous 60 day period using latex without the added glass filler.

Run Speed: The run speed was determined by systematically increasing the line speed on each style during the trial runs using latex with glass filler until measurements with a moisture meter indicated that the latex was not adequately dried. The line speed was then backed down until the latex measured adequately dry and left at that speed to complete the style. The maximum line speeds by style that achieved adequate drying levels was then compared to the line speeds for that same style using latex without the glass filler over the prior 60 days.

### Example 1

In the carpet industry, SBR Latex typically is used as the adhesive layer for adhering secondary backings onto tufted carpet. To provide improved flexibility, improved economics and shorter curing time various fillers have been added to SBR latex, some with marginal success.

In the batch process of an SBR latex, calcium carbonate filler was added at the rate of 2.0 lb. per 1 lb. of latex and ground glass filler was added at the rate of 0.25 lb. per 1 lb. of latex. Using this compound to adhere secondary backing to carpet it was found that the lamination strength was increased significantly, when compared to use of 1.9 lb. of calcium carbonate per lb of latex, without any ground glass filler added.

The results are shown in Table 1 below:

TABLE 1

| | Lamination | Lamiantion | |
|---|---|---|---|
| | Strength w/ | Strength w/o | Percent |
| Sample No. | glass (lbs/inch) | glass (lbs/inch) | Increase |
| A | 5.21 | 4.50 | 16% |
| B | 7.54 | 6.37 | 18% |
| C | 6.15 | 4.86 | 27% |
| D | 6.31 | 5.50 | 15% |
| Average | 6.30 | 5.31 | 19% |

The lamination strength of the carpet prepared using an adhesive comprising the finely divided glass particles had, on average, a lamination strength of about 6.30, which was about 20% greater than the lamination strength of an otherwise identical carpet prepared using no finely divided glass particles.

### Example 2

Using the same adhesive formulations as in Example 1 above, the inventor discovered that curing time of the rubber latex formulation that included the finely divided ground glass particles was reduced causing a significant increase in processing speed. The results are shown in Table 2 below.

TABLE 2

| | | | |
|---|---|---|---|
| | Run Speed | Run Speed | Percent |
| Carpet Style | w/glass | w/o glass | Increase |

| | | | | | |
|---|---|---|---|---|---|
| Ballina | 30 | fpm | 26 | fpm | 15% |
| Kinsale | 31 | fpm | 24 | fpm | 29% |
| Flat Weave | 29 | fpm | 25 | fpm | 16% |
| Bijoux | 31 | fpm | 26 | fpm | 19% |
| Average | 30.25 | fpm | 25.25 | fpm | 19.8% |

Table 2 reveals that carpet made using the adhesive formulations of the embodiments enabled a dramatic increase in run speed, on the order of about 20% increase on average.

The above examples reveal that the addition of finely divided glass particles, preferably ground glass, as a portion of the rubber latex filler results in improved lamination strength and decreased curing time resulting in higher run speeds and increased capacity.

Other embodiments, uses, and advantages of the embodiments will be apparent to those skilled in the art from consideration of the specification and practice of the invention disclosed herein. The specification should be considered exemplary only.

What is claimed is:

1. A carpet backing comprising an adhesive composition adhered to a carpet substrate, said adhesive composition comprising a rubber latex comprised of at least one conjugated diene, finely divided glass particles, and at least one filler.

2. The carpet backing as claimed in claim 1, wherein the at least one filler is selected from the group consisting of calcium carbonate, aluminum hydroxide, magnesium hydroxide, clay, barium sulfate, silicic acid, silicate, titanium oxide, magnesium carbonate, and mixtures thereof.

3. The carpet backing as claimed in claim 2, wherein the at least one filler is calcium carbonate.

4. The carpet backing as claimed in claim 1, wherein the at least one filler is present in an amount of from about 1 part by weight to about 5 parts by weight, per weight of rubber latex.

5. The carpet backing as claimed in claim 1, wherein the finely divided glass is selected from the group consisting of powdered glass, powdered sand, powdered quartz, powdered silica-containing ceramics, and mixtures thereof.

6. The carpet backing as claimed in claim 1, wherein the finely divided glass comprises particles having an average mesh size of from about 40 to about 250 mesh.

7. The carpet backing as claimed in claim 1, wherein the finely divided glass particles are present in an amount of from about 0.1 to about 1.5 parts by weight, based on the weight of the rubber latex.

8. The carpet backing as claimed in claim 7, wherein the finely divided glass particles are present in an amount of from about 0.15 to about 0.50 parts by weight, based on the weight of the rubber latex.

9. The carpet backing as claimed in claim 1, wherein the conjugated diene is selected from the group consisting of butadiene, isoprene, chloroprene.

10. The carpet backing as claimed in claim 1, wherein the rubber latex is comprised of at least one copolymer of a conjugated diene and an ethylenecially unsaturated monomer.

11. The carpet backing as claimed in claim 1, wherein the composition cures faster than an adhesive composition that does not contain finely divided glass particles.

12. The carpet backing as claimed in claim 11, wherein the curing time is from about 10 to about 50% faster.
